(19) United States
(12) Patent Application Publication
(10) Pub. No.: US 2024/0009619 A1
(43) Pub. Date: Jan. 11, 2024

(54) HEATING SYSTEM FOR COMPRESSED PARTS CAPABLE OF CONTROLLING PROCESS ATMOSPHERE AND PRESSURE

(71) Applicant: TANGTECK EQUIPMENT INC., Taoyuan City (TW)

(72) Inventors: MING-HUI YU, Taoyuan City (TW); CHANG-FA CHEN, Taoyuan City (TW); CHIA-JUNG KAO, Taoyuan City (TW); REN-WEN SHIU, Taoyuan City (TW)

(21) Appl. No.: 18/219,781

(22) Filed: Jul. 10, 2023

(30) Foreign Application Priority Data
Jul. 11, 2022 (TW) 111125850

(51) Int. Cl. B01D 53/76; H01G 13/00; B01D 53/00; B01D 53/34; B01D 53/44

(52) U.S. Cl. CPC B01D 53/76; H01G 13/00; B01D 53/005; B01D 53/346; B01D 53/44; B01D 2251/102; B01D 2257/704

(57) ABSTRACT

A heating system for compressed parts capable of controlling process atmosphere and pressure includes an accommodating body, a heating device, an atmosphere controlling device, and a processing pressure adjusting device. The heating device is disposed inside or outside of the accommodating body to heat a component to be heated, so as to remove an impurity within the component to be heated. The atmosphere controlling device transports a reaction gas, such as hydrogen, oxygen, water vapor, or plasma, into a cavity for reacting with the impurity within the component to be heated. A phase transition or a chemical reaction can be carried out, such that the impurity is gasified, oxidized, carbonized, or disintegrated. The processing pressure adjusting device uses an inert gas (e.g., a nitrogen gas or an argon gas) to control the processing pressure in the cavity to be from 800 Torr to 10⁻² Torr.

### CROSS-REFERENCE TO RELATED PATENT APPLICATION

This application claims the benefit of priority to Taiwan Patent Application No. 111125850, filed on Jul. 11, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a heating system, and more particularly to a heating system for compressed parts capable of controlling process atmosphere and pressure.

### BACKGROUND OF THE DISCLOSURE

In the manufacturing process of components such as electroceramics, heating is required for removal of impurities from the components. Conventionally, heating of the component is performed at an atmospheric pressure. Since the component to be heated has complex impurities and multiple boiling points, the component can only be slowly heated to prevent occurrences of layer cracking, peeling, etc. Therefore, it is difficult to shorten the processing time, and the processing yield is low.

### SUMMARY OF THE DISCLOSURE

In response to the above-referenced technical inadequacies, the present disclosure provides a heating system for compressed parts capable of controlling process atmosphere and pressure, so as to shorten the processing time and improve the processing yield.

In order to solve the above-mentioned problems, one of the technical aspects adopted by the present disclosure is to provide a heating system for compressed parts capable of controlling process atmosphere and pressure. The heating system includes an accommodating body, a heating device, an atmosphere controlling device, and a processing pressure adjusting device. The accommodating body has a cavity therein. The cavity is capable of accommodating a component to be heated. The heating device is disposed inside or outside of the accommodating body, and the heating device is used to heat the component to be heated, so as to remove an impurity within the component to be heated. The atmosphere controlling device is connected to the accommodating body, and the atmosphere controlling device is used to transport a reaction gas into the cavity. The processing pressure adjusting device is connected to the accommodating body, and the processing pressure adjusting device is used to control the processing pressure in the cavity.

In one of the possible or preferred embodiments, a bottom side of the accommodating body is an opening, the accommodating body is disposed on a cooling seat that is a hollow seat base, and a top side and a bottom side of the cooling seat are each an opening. The accommodating body is disposed on the top side of the cooling seat, a liquid-cooling pipe is disposed on the cooling seat, and the bottom side of the cooling seat is able to be sealed by using a bottom cover. The bottom cover is connected to at least one bottom cover driving member, and the at least one bottom cover driving member drives the bottom cover to be lifted or lowered, so that the bottom cover is placed on the bottom side of the cooling seat or is detached from the bottom side of the cooling seat.

In one of the possible or preferred embodiments, the heating device is disposed on an elevation seat, the elevation seat is connected to at least one elevation driving member, and the at least one elevation driving member drives the elevation seat to be lifted or lowered, so that the elevation seat and the heating device are selectively disposed on the accommodating body.

In one of the possible or preferred embodiments, the processing pressure adjusting device uses an inert gas to adjust the processing pressure to be from 800 Torr to 10⁻² Torr.

In one of the possible or preferred embodiments, a working platform is disposed in the cavity, and the working platform allows the component to be heated to be placed thereon. The working platform is connected to at least one working platform driving member, and the at least one working platform driving member drives the working platform to be raised or lowered.

Therefore, the heating system for compressed parts capable of controlling process atmosphere and pressure provided by the present disclosure includes an accommodating body, a heating device, an atmosphere controlling device, and a processing pressure adjusting device. The heating device is disposed inside or outside of the accommodating body, and is used to heat a component to be heated, so as to remove an impurity within the component to be heated. The atmosphere controlling device is connected to the accommodating body, and is used to transport a reaction gas into the cavity. The processing pressure adjusting device is connected to the accommodating body, and is used to control the processing pressure in the cavity. Since the atmosphere controlling device of the present disclosure can transport the reaction gas into the cavity, and the processing pressure adjusting device can control the processing pressure in the cavity, a capability of removing the impurity is enhanced, thereby shortening the processing time and improving the processing yield.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a heating system for compressed parts capable of controlling process atmosphere and pressure according to the present disclosure;

FIG. 2 is a schematic front view of the heating system for compressed parts capable of controlling process atmosphere and pressure according to the present disclosure;

FIG. 3 is a schematic right side view of the heating system for compressed parts capable of controlling process atmosphere and pressure according to the present disclosure;

FIG. 4 is a schematic top view of the heating system for compressed parts capable of controlling process atmosphere and pressure according to the present disclosure;

FIG. 5 is a cross-sectional view taken along line V-V of FIG. 4; and

FIG. 6 is a functional block diagram of the heating system for compressed parts capable of controlling process atmosphere and pressure according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Embodiment

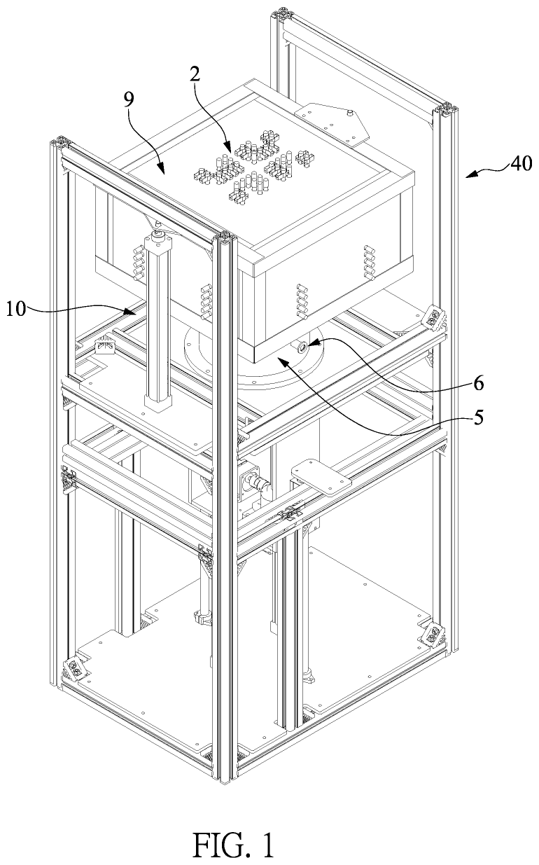

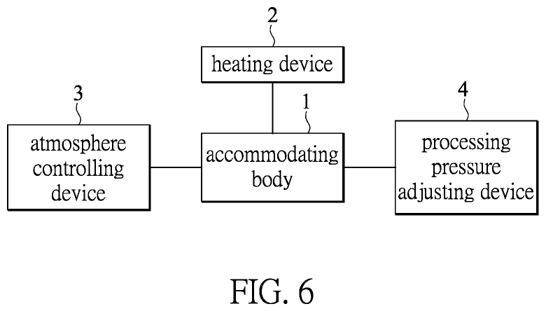

Referring to FIG. 1 and FIG. 6, the present disclosure provides a heating system for compressed parts capable of controlling process atmosphere and pressure. The heating system includes an accommodating body 1, a heating device 2, an atmosphere controlling device 3, and a processing pressure adjusting device 4.

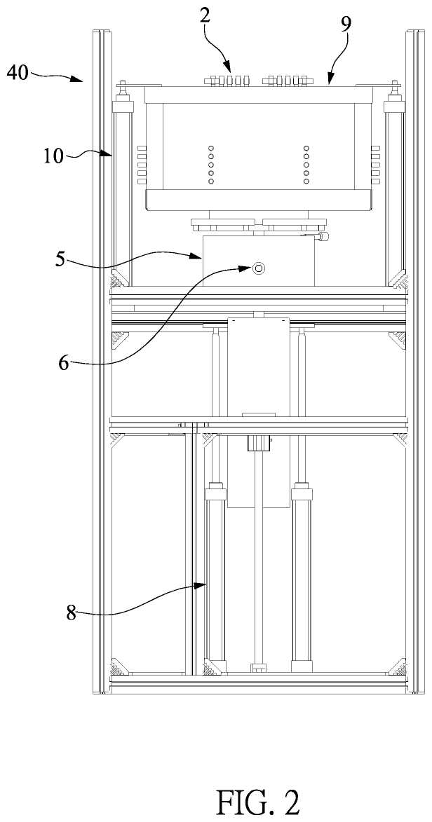

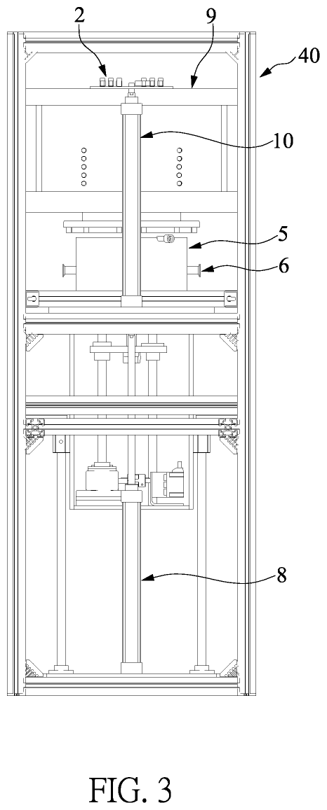

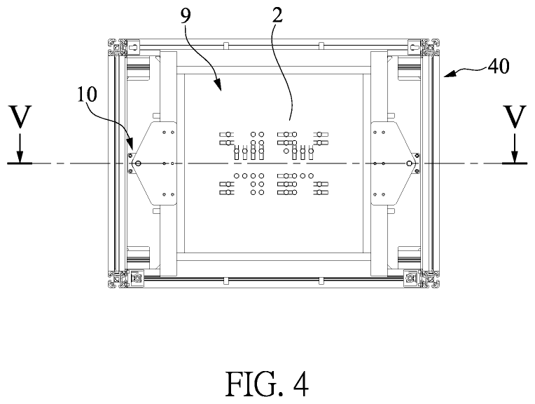

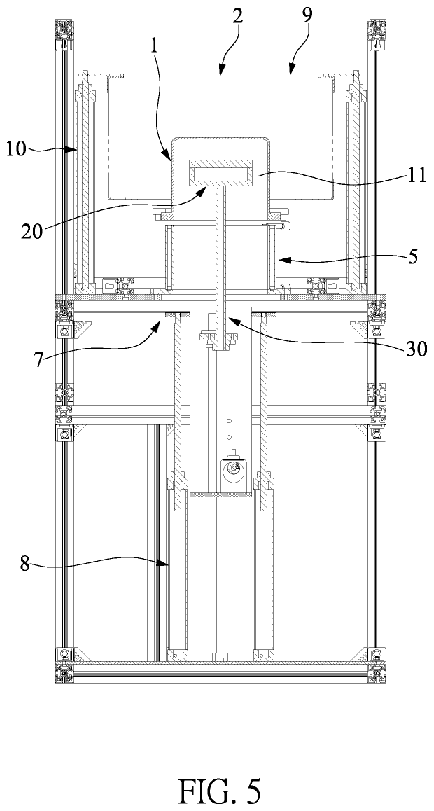

Reference is further made to FIG. 2 to FIG. 5. The accommodating body 1 can be, for example, a quartz tube, and is a heat-resistant and closed member. As shown in FIG. 5, the accommodating body 1 has a cavity 11 therein that is capable of accommodating a component to be heated. The component to be heated can be an electroceramic, such as a ceramic capacitor. A bottom side of the accommodating body 1 is an opening, the accommodating body 1 can be disposed on a cooling seat 5 that is a hollow seat base, and a top side and a bottom side of the cooling seat 5 are each an opening. The accommodating body 1 is disposed on the top side of the cooling seat 5, and the cooling seat 5 is made of a metal material having good thermal conduction, such as aluminum. A liquid-cooling pipe 6 can be disposed on the cooling seat 5 to cyclically transport a cooling liquid, thereby facilitating cooling and lowering a temperature of the accommodating body 1.

As shown in FIG. 5, the bottom side of the cooling seat 5 can be sealed by using a bottom cover 7. In this embodiment, the bottom cover 7 is connected to at least one bottom cover driving member 8 that can be an air cylinder. The at least one bottom cover driving member 8 can drive the bottom cover 7 to be lifted or lowered, so that the bottom cover 7 can be placed on the bottom side of the cooling seat 5 to close off the bottom side of the cooling seat 5, or can be detached from the bottom side of the cooling seat 5 to open the bottom side of the cooling seat 5.

The heating device 2 is disposed inside or outside of the accommodating body 1, and a structure of the heating device 2 is not limited in the present disclosure. The heating device 2 can be various types of heating apparatuses. For example, the heating device 2 is an infrared heater that can be used in conjunction with the accommodating body 1 that is the quartz tube, so as to achieve an improved heating effect. The heating device 2 can be used to heat the component to be heated, so as to remove an impurity within the component to be heated. Generally, the impurity as mentioned herein is an organic solvent to be removed.

A heating temperature of the heating device 2 can range from 200° C. to 500° C., such as 200° C., 210° C., 220° C., 230° C., 240° C., 250° C., 300° C., 350° C., 400° C., 450° C., or 500° C. Preferably, the heating temperature of the heating device 2 ranges from 300° C. to 500° C., so that the impurity within the component to be heated can be more effectively removed. The heating temperature of the heating device 2 is not limited in the present disclosure, and can be adjusted according to practical requirements.

In the present embodiment, the heating device 2 is disposed on an elevation seat 9, the elevation seat 9 is connected to at least one elevation driving member 10 that can be an air cylinder, and the elevation driving member 10 can drive the elevation seat 9 to be lifted or lowered, so that the elevation seat 9 and the heating device 2 are selectively disposed on the accommodating body 1. When the elevation seat 9 and the heating device 2 are detached from the accommodating body 1, the accommodating body 1 is rapidly cooled.

As shown in FIG. 6, the atmosphere controlling device 3 is connected to the accommodating body 1. The atmosphere controlling device 3 can transport a reaction gas into the cavity 11. The reaction gas is selected from the group consisting of hydrogen, oxygen, water vapor, and plasma, but the type of the reaction gas is not limited in the present disclosure. The reaction gas can react with the impurity within the component to be heated to carry out a phase transition or a chemical reaction, such that the impurity is gasified, oxidized, carbonized, or disintegrated. Therefore, the impurity can be rapidly removed, and a processing temperature can be significantly lowered. In the present embodiment, the reaction gas can be used to react with the organic solvent, and the reaction gas can be oxygen that is used to oxidize the organic solvent.

As shown in FIG. 6, the processing pressure adjusting device 4 is connected to the accommodating body 1, and the processing pressure adjusting device 4 can be used to control the processing pressure in the cavity 11. The processing pressure adjusting device 4 uses an inert gas (e.g., a nitrogen gas or an argon gas) to adjust the processing pressure to be from 800 Torr to 10⁻² Torr. The processing pressure can be 800 Torr, 700 Torr, 600 Torr, 500 Torr, 400 Torr, 300 Torr, 200 Torr, 100 Torr, 50 Torr, 10 Torr, 10⁻¹ Torr, or 10⁻² Torr. Furthermore, the processing pressure adjusting device 4 can adjust the gas pressure to facilitate reactions, so as to shorten the processing time. In detail, the processing pressure adjusting device 4 can adjust the processing pressure to be lowered. The lower the pressure is, the lower boiling points become. Accordingly, the processing time is shortened. Preferably, the processing pressure adjusting device 4 controls the processing pressure in the cavity 11 to be a negative pressure, such as a micro-negative pressure, so as to facilitate disintegration and cracking of organic compositions (e.g., organic solvents). In addition, gas within the component to be heated can be rapidly discharged and does not remain in the component to be heated.

As shown in FIG. 5, a working platform 20 can be disposed in the cavity 11, and the working platform 20 allows the component to be heated to be placed thereon. The working platform 20 is connected to at least one working platform driving member 30 that can be a motorized screw rod. The at least one working platform driving member 30 can drive the working platform 20 to be raised or lowered. As such, the component to be heated can be rapidly moved outside of a heating area by the working platform 20 and be cooled, so that a temperature of the component to be heated is lowered. In the present embodiment, the heating system further includes a rack 40 to support and fix members such as the accommodating body 1 and the heating device 2.

### Beneficial Effects of the Embodiment

In conclusion, the heating system for compressed parts capable of controlling process atmosphere and pressure provided by the present disclosure includes an accommodating body, a heating device, an atmosphere controlling device, and a processing pressure adjusting device. The heating device is disposed inside or outside of the accommodating body, and is used to heat the component to be heated, so as to remove an impurity within the component to be heated. The atmosphere controlling device is connected to the accommodating body, and is used to transport a reaction gas into the cavity. The processing pressure adjusting device is connected to the accommodating body, and is used to control the processing pressure in the cavity. Since the atmosphere controlling device of the present disclosure can transport the reaction gas into the cavity, and the processing pressure adjusting device can control the processing pressure in the cavity, a capability of removing the impurity is enhanced, thereby shortening the processing time and improving the processing yield.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A heating system for compressed parts capable of controlling process atmosphere and pressure, comprising:
an accommodating body having a cavity therein, wherein the cavity is capable of accommodating a component to be heated;
a heating device disposed inside or outside of the accommodating body, wherein the heating device is used to heat the component to be heated, so as to remove an impurity within the component to be heated;
an atmosphere controlling device connected to the accommodating body, wherein the atmosphere controlling device is used to transport a reaction gas into the cavity; and
a processing pressure adjusting device connected to the accommodating body, wherein the processing pressure adjusting device is used to control the processing pressure in the cavity.

2. The heating system according to claim 1, wherein a bottom side of the accommodating body is an opening, the accommodating body is disposed on a cooling seat that is a hollow seat base, and a top side and a bottom side of the cooling seat are each an opening; wherein the accommodating body is disposed on the top side of the cooling seat, a liquid-cooling pipe is disposed on the cooling seat, and the bottom side of the cooling seat is able to be sealed by using a bottom cover; wherein the bottom cover is connected to at least one bottom cover driving member, and the at least one bottom cover driving member drives the bottom cover to be lifted or lowered, so that the bottom cover is placed on the bottom side of the cooling seat or is detached from the bottom side of the cooling seat.

3. The heating system according to claim 1, wherein the heating device is disposed on an elevation seat, the elevation seat is connected to at least one elevation driving member, and the at least one elevation driving member drives the elevation seat to be lifted or lowered, so that the elevation seat and the heating device are selectively disposed on the accommodating body.

4. The heating system according to claim 1, wherein the reaction gas is selected from the group consisting of hydrogen, oxygen, water vapor, and plasma.

5. The heating system according to claim 1, wherein the processing pressure adjusting device uses an inert gas to adjust the processing pressure to be from 800 Torr to 10⁻² Torr.

6. The heating system according to claim 1, wherein a working platform is disposed in the cavity, and the working platform allows the component to be heated to be placed thereon; wherein the working platform is connected to at least one working platform driving member, and the at least one working platform driving member drives the working platform to be raised or lowered.

7. The heating system according to claim 1, wherein the component to be heated is an electroceramic.

8. The heating system according to claim 1, wherein the accommodating body is a quartz tube, and the heating device is an infrared heater.

9. The heating system according to claim 1, wherein the impurity is an organic solvent within the component to be heated, the reaction gas is capable of reacting with the organic solvent, and the processing pressure adjusting device controls the processing pressure in the cavity to be a negative pressure, so as to rapidly discharge gas within the component to be heated.

10. The heating system according to claim 9, wherein a heating temperature of the heating device ranges from 300° C. to 500° C.
